(19) United States
(12) Patent Application Publication
(10) Pub. No.: US 2006/0130617 A1
(43) Pub. Date: Jun. 22, 2006

(54) Catheter connector wrench

(76) Inventor: Alexander Charles Mamourian, Hanover, NH (US)

Correspondence Address: LATHROP & GAGE LC, 4845 PEARL EAST CIRCLE, SUITE 300, BOULDER, CO, 80301, US

(21) Appl. No.: 11/017,513

(22) Filed: Dec. 20, 2004

(51) Int. Cl. B25B 13/02

(52) U.S. Cl. 81/119

(57) ABSTRACT

A catheter connector wrench for use with a connector mounted to a tubular catheter is disclosed. The catheter connector has flanges for facilitating the tightening and release of the connector. The catheter connector wrench has a body with a perimeter wall, an inner wall defining an aperture, and a slot extending from the perimeter wall to the aperture. The slot permits passage of the catheter into the aperture as the wrench is mounted to the connector. The inner wall of the body has one or more wrench hollows that accept the flanges of the connector, so that the wrench engages the connector for facilitating rotation of the connector.

### BACKGROUND

A tubular catheter used in medical diagnostic procedures and/or surgery may connect with another device, using a connector. For example, during an angiographic procedure, the connector couples the catheter with a contrast injector. This connector may be engaged and disengaged one or more times during a diagnostic or surgical procedure, and may jam during engagement or disengagement. Rectifying connector jams may require application of considerable force, which may be difficult for surgical personnel to do with gloved hands; it may also take valuable time during an operating procedure.

### SUMMARY

A catheter connector wrench is used with a connector mounted to a tubular catheter. The catheter connector has flanges for facilitating the tightening and release of the connector. The catheter connector wrench has a body with a perimeter wall, an inner wall defining an aperture, and a slot extending from the perimeter wall to the aperture. The slot permits passage of the catheter into the aperture as the wrench is mounted to the connector. The inner wall of the body has one or more wrench hollows that accept the flanges of the connector, so that the wrench engages the connector for facilitating rotation of the connector.

### BRIEF DESCRIPTION OF DRAWINGS

FIG. 1 shows a perspective view of one catheter connector wrench.

FIG. 2 and FIG. 3 illustrate how the catheter connector wrench of FIG. 1 may be used with a catheter connector.

### DETAILED DESCRIPTION OF DRAWINGS

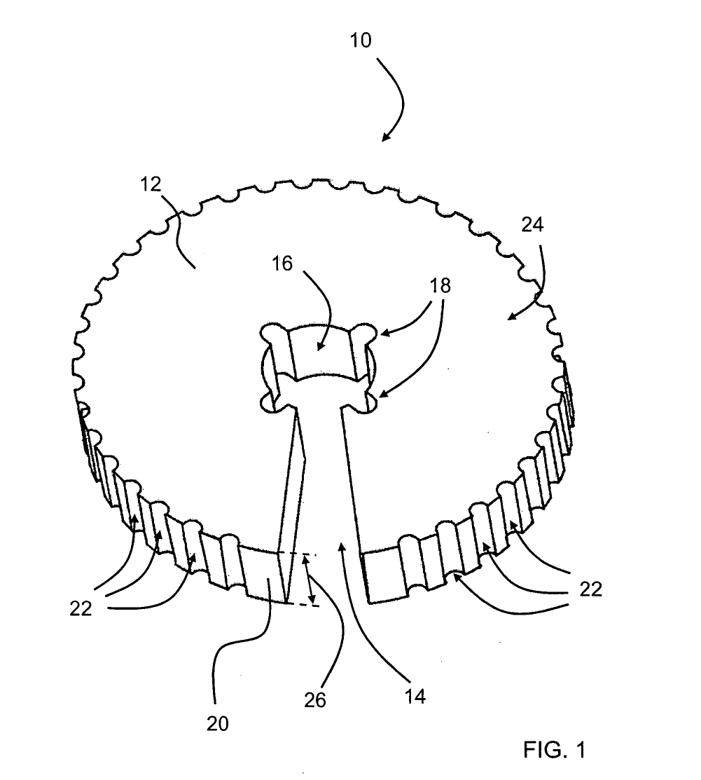

FIG. 1 shows a perspective view of a catheter connector wrench 10, in accord with one embodiment. Wrench 10 has a body 12 that forms a slot 14, a central cavity 16, and one or more wrench hollows 18. Slot 14 connects with central cavity 16, as shown. An outer edge 20 of wrench 10 forms grooves 22 that may be gripped by a user of wrench 10. Body 12 has a top surface 24 and a bottom surface (hidden in FIG. 1) separated by a thickness 26. Body 12 is, for example, formed of plastic.

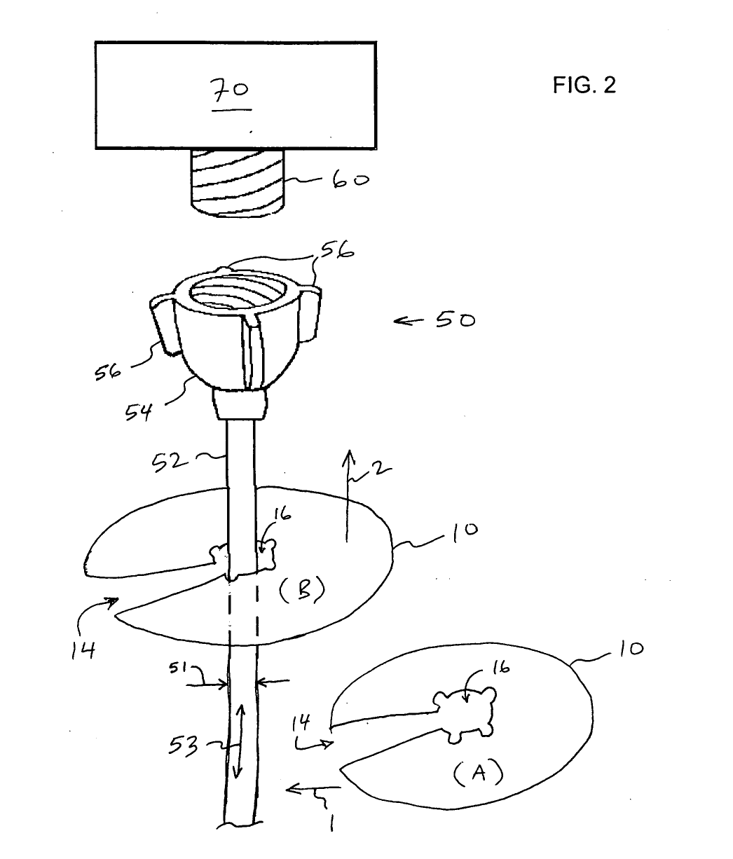

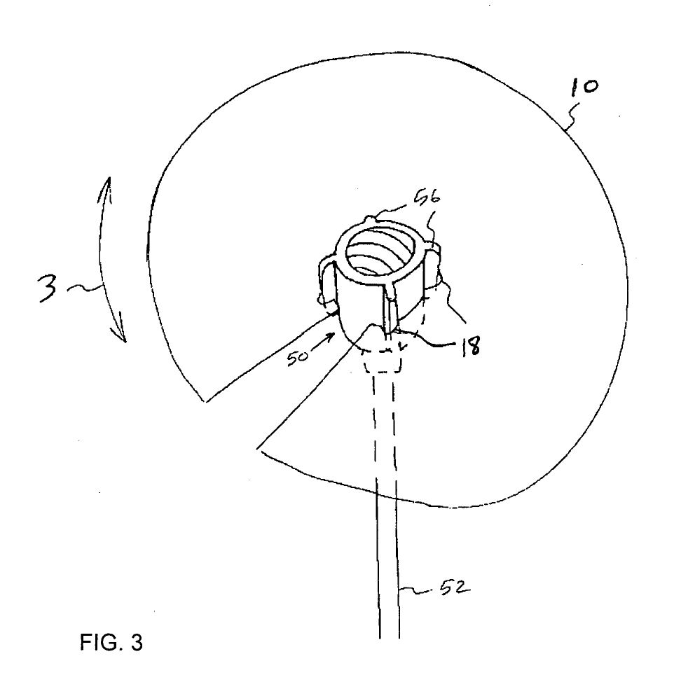

FIG. 2 and FIG. 3 illustrates, by way of example, how wrench 10 may be used with a catheter connector 50. In the example, a catheter 52 connects to connector 50; and connector 50 connects with a fitting 60 of a contrast injector 70, as shown. Connector 50 has a body 54 with flanges 56. To couple with catheter connector 50, wrench 10 is first positioned, as illustrated in position (A), and then moved in the direction of arrow 1 so that a cross-sectional dimension 51 of catheter 52 passes through slot 14, to reach cavity 16, as illustrated in position (B).

Accordingly, slot 14 enables use of wrench 10 when connector 50 is already attached to a fitting; that is, access to an end of catheter 52 is not needed to position wrench 10 over connector 50. Wrench 10 may then be moved in the direction of arrow 2 so that a lengthwise dimension 53 of catheter 52 passes through cavity 16 as wrench 10 approaches connector 50.

Once wrench 10 reaches connector 50, cavity 16 passes over body 54 of connector 50, and wrench hollows 18 pass over flanges 56 of connector 50, as shown in FIG. 3. When positioned as in FIG. 3, wrench 10 may be turned in either direction indicated by arrow 3 so that wrench hollows 18 engage flanges 56 to turn connector 50, for example to tighten or loosen connector 50 relative to fitting 60.

Catheter connector wrench 10 may provide certain advantages. Slot 14 enables use of wrench 10 even though connector 50 remains connected to catheter 52, and catheter 52 may couple with a patient. Wrench 10 may further provide leverage to assist a user in turning connector 50; such leverage may be necessary, for example, when connector 50 is jammed onto fitting 60. Grooves 22 may make it easier to grip wrench 10 (for example, with a gloved hand) and rotate connector 50, as compared to gripping and rotating connector 50 without using wrench 10.

Although catheter connector wrench 10 of FIG. 1 and FIG. 2 is shown with four wrench hollows 18, to engage a corresponding four flanges 56 of connector 50, other embodiments of a catheter connector wrench 50 may have different numbers or shapes of wrench hollows to engage with corresponding features of other connectors. Although top surface 24 of catheter wrench 10 is shown in FIG. 1 as flat, other embodiments of a catheter connector wrench may not be flat (e.g., top surface 24 and a corresponding bottom surface may be curved or differently shaped). Catheter connector wrench 10 may be constructed by cutting or stamping flat plastic, or by a plastic molding process, for example.

Changes may be made in the catheter connector wrench described herein without departing from the scope hereof. For example, the catheter connector wrench need not be round, but may be other shapes (e.g., oval, rectangular, hexagonal). In another example, gripping elements may not be present on an outer rim of a catheter connector wrench, or gripping elements other than grooves may be present; for example, small knobs or a coating (e.g., rubber) may be placed on outer surface 20. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A catheter connector wrench for use with a connector mounted to a tubular catheter, the connector having flanges for facilitating the tightening and release of the connector, the wrench comprising:
a body having a perimeter wall,
an inner wall defining an aperture, and
a slot extending from the perimeter wall to the aperture for permitting passage of the tubular catheter into the aperture as the wrench is mounted to the connector,
the inner wall of the body further having one or more wrench hollows operably configured to accept the flanges of the connector as the wrench engages the connector for facilitating rotation of the connector.

2. The catheter connector wrench of claim 1, the perimeter wall of the body forming one of an oval, a rectangle and a hexagon.

3. The catheter connector wrench of claim 1, the body comprising plastic.

4. The catheter connector wrench of claim 1, wherein the inner wall of the body has two, three, four, five, or six wrench hollows.

5. The catheter connector wrench of claim 1, further comprising one or more gripping elements disposed with the perimeter wall, to facilitate rotation of the catheter connector wrench by a human hand.

6. The catheter connector wrench of claim 5, wherein the gripping elements comprise one or more grooves in the body.

7. The catheter connector wrench of claim 5, wherein the gripping elements comprise one or more knobs connected with the perimeter wall.

8. The catheter connector wrench of claim 5, wherein the gripping elements comprise a coating on the perimeter wall.

9. The catheter connector wrench of claim 8, the coating comprising rubber.

10. A method for loosening or tightening a catheter connector, comprising:
passing a cross-sectional dimension of a tubular catheter through a slot of a catheter connector wrench to position an aperture of the catheter connector wrench about the catheter,
passing a lengthwise dimension of the catheter through the aperture to position the catheter connector wrench about flanges of a catheter connector, so that wrench hollows of the catheter connector wrench engage flanges of the catheter connector; and
rotating the catheter connector wrench to turn the catheter connector.

11. The method of claim 10, wherein the step of rotating comprises gripping gripping elements on a perimeter wall of the catheter connector wrench to facilitate turning the catheter connector.

12. A catheter connector wrench, comprising:
a body forming (a) a slot, (b) an aperture connected with the slot, and (c) one or more wrench hollows connected with the aperture,
the body being positionable about a catheter that connects with a catheter connector, by passing a cross-sectional dimension of the catheter through the slot and by passing a lengthwise dimension of the catheter through the aperture,
the aperture being adapted to fit about the catheter connector such that the wrench hollows engage one or more flanges of the connector, wherein rotating the body turns the catheter connector.
